(19) United States
(12) Patent Application Publication
(10) Pub. No.: US 2002/0021526 A1
(43) Pub. Date: Feb. 21, 2002

(54) METHOD AND APPARATUS FOR CONTROLLING A VOICE COIL MOTOR OF A HARD DISK DRIVE

(76) Inventor: EVERT S. COOPER, MORGAN HILL, CA (US)

Correspondence Address: TEXAS INSTRUMENTS INCORPORATED, P O BOX 655474, M/S 3999, DALLAS, TX, 75265

(21) Appl. No.: 08/985,380

(22) Filed: Dec. 4, 1997

(51) Int. Cl. G11B 21/02; G11B 5/596

(52) U.S. Cl. 360/78.09

(57) ABSTRACT

A hard disk drive device (11) includes an actuator (16) controlling movement of read/write heads (20) relative to a stack (12) of rotating disks. A control arrangement (30) for controlling the actuator includes a control loop (50) using a model reference control portion (68, 76) to generate a first digital positioning signal component (72), and using a further control portion (66, 60, 62, 64) to generate a second digital positioning signal component. Two low-precision digital-to-analog converters (54, 56) respectively convert the first and second digital positioning signal components to respective analog positioning signal components (61, 59). A summing junction (57) combines the analog positioning signal components in a manner giving one greater weight than the other in a resulting analog positioning signal (48), which is applied to the actuator.

### BACKGROUND OF THE INVENTION

Digital-to-analog converters (DACS) are used in a variety of electronic devices and systems, such as in the control circuitry of a hard disk drive mass storage device. DACs can be generally categorized as high-precision DACs and low-precision DACs, the classification of which depends upon the design of the particular electronic system and the demands needed of a particular DAC in that electronic system.

As an example, a DAC which is used in the control circuitry of a hard disk drive system, and which provides a resolution of twelve or more bits, would be considered a high-precision DAC. In a hard disk drive system, a high-precision DAC may be used to generate a signal which ultimately controls the current in a voice coil motor or other actuator used to position a read/write head. More specifically, the DAC converts a digital signal which has been processed by a microprocessor, such as a digital signal processor (DSP), into an analog signal which is applied to the actuator controlling the position of the read/write head.

As the track densities of hard disk drives increase and/or as access times decrease with greater coil current, a need for even higher resolution DACs will develop. For example, as more tracks are included on a disk, the width of the tracks decreases, and there is an increase in the degree of resolution needed to accurately position the head and to avoid mechanical resonances. Although high resolution DACs are commercially available, they are relatively expensive. A single high resolution DAC may cost several times as much as a single low resolution DAC. High resolution DACs are thus undesirable in the hard disk drive industry, which is very cost sensitive.

High-precision DACs suffer from some other drawbacks and disadvantages. Often, high-precision DACs cannot be implemented in silicon alongside other circuitry, such as a digital signal processor, because the low precision of the semiconductor process used to implement the other circuitry does not provide the needed high-precision circuit elements for a high-precision DAC, and it is not cost effective to use a high-precision semiconductor process. Further, because high-precision DACs are relatively large circuits, they are expensive to fabricate and consume significant amounts of power. Power consumption is especially critical in portable devices such as laptop or notebook computers, because of the desirability of minimizing power consumption in order to maximize the computing time obtained from a fully charged battery.

One alternative is to use a single low-precision DAC and to switch it from coarse resolution control during track seeking to fine resolution control during track following. However, this is not entirely satisfactory, because the switch between resolutions, which occurs just as the target track is reached, creates actuator control transients that prolong actuator settling time.

### SUMMARY OF THE INVENTION

From the foregoing it may be appreciated that a need has arisen for a method and apparatus for controlling an actuator, such as a voice coil motor of a hard disk drive, which solve the problems of using a high-precision DAC.

According to the present invention, a method and apparatus are provided for controlling an actuator which includes a movable member and which is responsive to an actuator control signal for effecting movement of the member, where a digital position error signal is generated to indicate an actual state of the member. The method and apparatus involve: utilizing a model reference control technique responsive to an input signal representing a desired or target position of the member to generate a digital first control signal which represents a control movement of the member, and to generate a second control signal which represents a state the actuator theoretically would be expected to assume in response to the digital first control signal; generating a digital third control signal in response to the digital position error signal, the digital first control signal, and the second control signal, wherein the digital third control signal represents a control movement of the member; converting the digital first control signal into an analog first control signal; converting the digital third control signal into an analog third control signal; and generating the actuator control signal by adding the analog first control signal and the analog third control signal in a manner so that the analog first control signal has greater weight than the analog third control signal.

### BRIEF DESCRIPTION OF THE DRAWINGS

For a more complete understanding of the present invention and the advantages thereof, reference is now made to the detailed description which follows, taken in connection with the accompanying drawings, in which:

FIG. 1 is a block diagram of a portion of a hard disk drive device which embodies the present invention;

FIG. 2 is a block diagram showing in more detail a control system which is part of the disk drive device of FIG. 1; and

FIG. 3 is a block diagram showing details of an exemplary implementation of a control system of the type shown in FIG. 2.

### DETAILED DESCRIPTION OF THE INVENTION

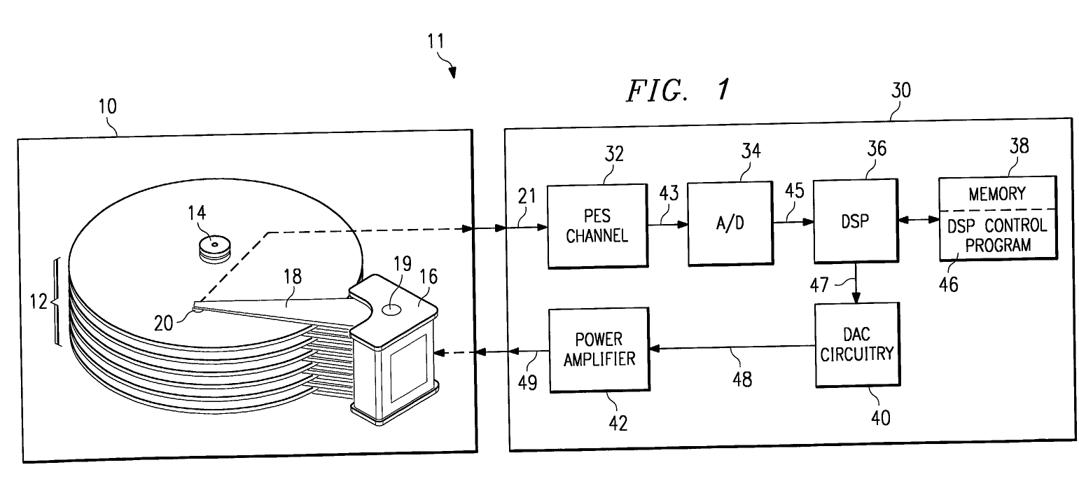

FIG. 1 is a block diagram of a hard disk drive device 11 which embodies the present invention. The hard disk drive device 11 includes a conventional head/disk assembly (HDA) 10 controlled by a control loop or control section 30, the control section 30 including a digital-to-analog converter (DAC) circuit 40 and a digital signal processor (DSP) 36. The head/disk assembly 10 includes a magnetic disk stack 12 fixedly supported on a spindle 14, the spindle 14 being rotationally driven by a conventional spindle motor (which is not shown in FIG. 1).

The head/disk assembly further includes an actuator which is a voice coil motor 16, and a plurality of suspension arms 18 which are all rotatably supported on an axle 19 that is parallel to the spindle 14, the axle 19 being fixedly supported on the actuator 16. The voice control motor 16 urges simultaneous pivotal movement of all of the arms 18 about the axle 19. A plurality of read/write heads 20 are provided on the arms 18 at the ends thereof remote from the axle 19, each head being adjacent a respective side of a respective disk of the stack 12. When the voice coil motor 16 pivots all of the arms 18 about the axle 19, the read/write heads 20 each move approximately radially with respect to a respective disk in the stack 12. Magnetic disk stack 12 is used to store information written to each side of each disk. The information is magnetically read from and written to each side of each disk by a respective one of the read/write heads 20. Generally, just one read/write head 20 is active at a time.

In a conventional manner, each side of each disk has a plurality of concentric tracks (not illustrated), and each track is divided into a plurality of arcuate sectors which are circumferentially distributed. Each sector of each track generally includes a not-illustrated servo wedge. The servo wedge provides position information, which is read by the associated read/write head 20 and then provided to the control section 30 as an analog servo wedge signal shown diagrammatically at 21.

Voice coil motor 16 is controlled by the control section 30. The control section 30 includes a position error signal (PES) channel 32, an analog-to-digital converter (ADC) circuit 34, a digital signal processor (DSP) 36, a memory 38, a digital-to-analog converter (DAC) circuit 40, and a power amplifier 42. In the disclosed embodiment, the components of the control section 30, including the DSP 36, the memory 38 and the DAC circuit 40, are fabricated in a single piece of semiconductor material, such as silicon. Further, the memory 38 is a flash memory, although other types of memory could also be used.

The PES channel 32 receives the analog servo wedge signal 21, and generates from it an analog position error signal 43. The analog servo wedge signal 21 is the raw analog signal read by a read/write head 20 off the associated disk or platter. The analog position error signal 43 may contain both track seeking and track following information, such as track identification information and position error information, respectively. Thus, the term position error signal is used herein to refer to both track following information and position error information. The analog position error signal 43 is converted by ADC 34 into a digital position error signal 45, which is then provided to DSP 36 for further processing.

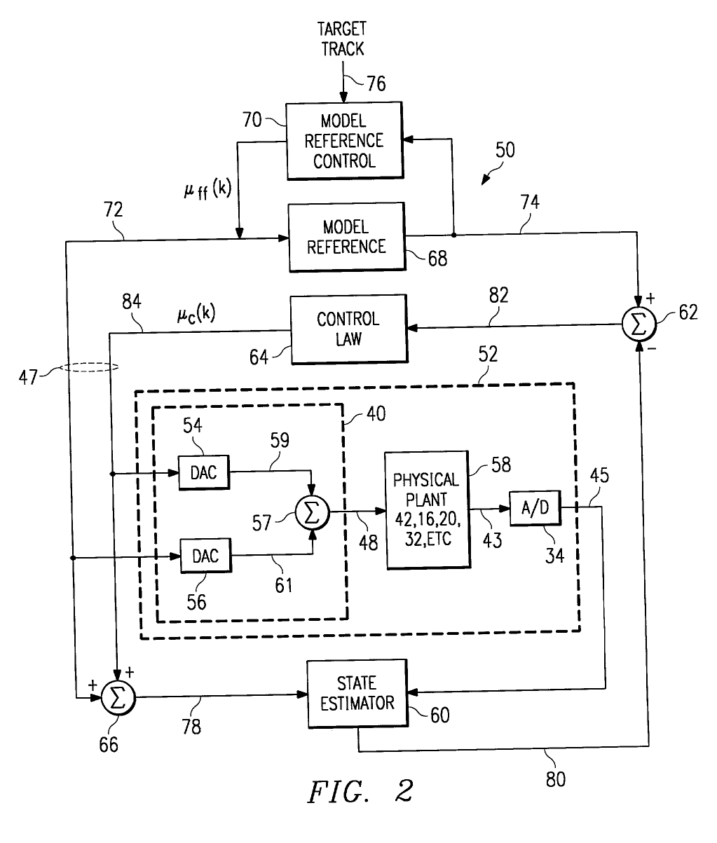

The DSP 36 receives the digital position error signal 45, and processes the signal using a control approach which is shown in FIG. 2 and described in more detail later. This control approach is implemented by a DSP control program 46, which is stored in the memory 38.

The DSP 36 outputs digital positioning information 47 to the DAC circuit 40, which converts the digital positioning information 47 into an analog positioning signal 48 that is supplied to the power amplifier 42. The power amplifier 42 produces at its output an amplified analog positioning signal 49, which is applied to and controls the voice coil motor 16.

FIG. 2 is a block diagram of the system of FIG. 1, showing in more detail the control approach implemented by the DSP 36 of FIG. 1. In FIG. 2, reference numeral 58 designates a block that represents the physical plant of the hard disk drive device 11, which with reference to FIG. 1 includes the power amplifier 42, the position error signal channel 32, and all of the components of the head/disk assembly 10. The output of the physical plant 58 is the analog positioning error signal 43 of FIG. 1, which is supplied to the analog-to-digital converter 34, which in turn outputs the digital positioning error signal 45. The input to the physical plant 58 is the analog positioning signal 48 from the digital-to-analog converter circuit 40.

As shown in FIG. 2, the digital-to-analog converter circuit 40 includes a first digital-to-analog converter 54 which outputs a first analog positioning signal component 59, a second digital-to-analog converter circuit 56 which outputs a second analog positioning signal component 61, and a summing junction 57 which adds the analog signal components 59 and 61. The output of the summing junction 57 is the analog positioning signal 48. The digital-to-analog converter circuits 54 and 56 are each a lowprecision DAC. For example, each can be an 8-bit DAC. The summing junction 57 adds the signal components 59 and 61 in a manner so that the signal component 61 has a significantly greater weight in the analog positioning signal 48 than the signal component 59. Stated differently, the least significant bit (LSB) of the DAC 56 effects a greater change in current or voltage of the signal 48 than the LSB of the DAC 54. The two low-precision DACs 54 and 56 together involve substantially less circuitry than a single high-precision DAC having, for example, 12 or 14 bits of resolution. Moreover, they can be implemented with a low-precision semiconductor process of the type used for a digital signal processor, and do not require a high-precision semiconductor process of the type needed for a high-precision DAC. Therefore, both of the DACs 54 and 56 can be implemented with a low-precision semiconductor process in a semiconductor material such as silicon with substantially less area and power consumption than a single high-precision DAC.

Since the signal component 61 is given more weight than the signal component 59 in determining the signal 48, the signal component 61 is used for coarse positioning control of the read/write head 20 (FIG. 1), while the signal component 59 is used for fine positioning of the read/write head 20. Thus, the signal component 61 is particularly suitable for control operations which involve a significant movement of the read/write heads 20, such as movement from one track to another track, whereas the signal component 59 is particularly suitable for small adjustments in the position of the read/write heads 20, such as accurately maintaining one of the read/write heads 20 in radial alignment with a particular track.

In FIG. 2, reference number 52 is used to collectively identify the digital-to-analog converter 40, the physical plant 58, and the analog-to-digital converter 34. The elements within block 52 in FIG. 2 represent elements which, in the disclosed embodiment, are actual physical circuits or mechanical parts. The elements outside the block 52 in FIG. 2 are all implemented in the form of the control program 46 (FIG. 1) executed by the DSP 36. Although the elements outside the block 52 are implemented by the control program in the disclosed embodiment, it will be recognized that they could alternatively be implemented as a control circuit which is made from discrete components and which replaces the DSP 36 of FIG. 1.

In the following explanation of FIG. 2, the term “signal” is used to refer to quantities which would take the form of electrical voltage or current if the control blocks of FIG. 2 were implemented as a physical circuit, and which take the form of numerical values within the DSP 36 in the disclosed embodiment of the invention.

In FIG. 2, the control loop or control section represented by the elements outside the block 52 is designated generally by reference numeral 50. The control loop 50 utilizes a model reference control technique which is represented by blocks 68 and 70. Block 68 is a model reference, which is a model of the control characteristics of the physical plant 58 of FIG. 2. The model reference 68 accepts as an input a feedforward control signal 72, and produces at its output a model control signal 74. The model control signal 74 represents the theoretical or expected response of the actual physical plant 58 if the feedforward control signal 72 were applied to the actual plant 58, and in particular represents a model control vector which includes theoretical or expected position, velocity and acceleration information for the arms 18. The block 70 is a model reference control which is responsive to the model control signal 74 and an input signal 76 identifying a desired or target track. The model reference control 70 generates the feedforward control signal 72 so as to control the model reference 68 in a manner which, in the actual physical plant 58, would cause a read/write head 20 to move to and then stay in radial alignment with a target track identified by the input signal 76.

The control loop 50 further includes a state estimator 60, which is responsive to the digital positioning error signal 45 from the analog-to-digital converter 34, as well as a digital positioning signal 78 from a summing junction 66 that is described in more detail later. The state estimator 60 outputs a state estimation signal 80 which is an estimated state vector of the physical plant 58, including a position, velocity and acceleration of the arms 18 supporting the read/write heads 20.

The control loop 50 includes a junction 62 which subtracts the state estimation signal 80 representing the estimated state vector from the model control signal 74 representing the model control vector, and outputs the vector difference on line 82 as a state error signal representing a state error vector. The junction 62 actually includes three not-illustrated junctions which respectively determine the difference between the position information in signals 74 and 80, the velocity information in signals 74 and 80, and the acceleration information in signals 74 and 80, and which output respective difference signals at 82 as state error information representing a state error vector. However, for convenience and to avoid confusion, these three junctions are shown as a single block 62 in FIG. 2.

The control loop 50 further includes a control law 64 which receives the state error information 82 representing the state error vector from the junction 62, and outputs at 84 a correction control signal. The state error information 82 in the disclosed embodiment actually represents three different signals, as mentioned above, and the control law 64 in the disclosed embodiment multiplies each such signal by a respective gain, and then sums the results to generate the correction control signal 84.

The feedforward control signal 72 may be represented by the term u_{ff}(k), and the correction control signal 84 may be represented by the term u_{c}(k), where “k” represents a sample number. In each case, “u” is a control variable which can be viewed as representing either voltage or current. The feedforward control signal 72 and the correction control signal 84 are respectively coupled to the inputs of the DACs 56 and 54, and together constitute the digital positioning information shown at 48 in the block diagram of FIG. 1. As mentioned above, the junction 57 adds the analog signal components 59 and 61 so that the signal component 61 has more weight in the resulting analog positioning signal 48 than the signal component 59. Consequently, it will be recognized that the feedforward control signal 72 has a greater effect on the analog positioning signal 48 than the correction control signal 84. The feedforward control signal 72 is thus used to effect large movements of the positioning arms 18 and read/write heads 20 (FIG. 1), such as moving a read/write head from one track to another, whereas the correction control signal 84 is used to effect fine tuning of the position of the arms 18 and heads 20, such as accurately maintaining one of the heads 20 in alignment with a particular selected track.

The junction 66 adds the digital feedforward control signal 72 and the correction control signal 84, in order to produce the digital positioning signal 78. In summing the signals 72 and 84, the junction 66 gives the signal 72 significantly greater weight than the signal 84, in a manner analogous to the way in which junction 57 gives signal component 61 greater weight than signal component 59. Thus, the digital positioning signal 78 produced by the junction 66 is a digital equivalent of the analog positioning signal 48 produced by the junction 57.

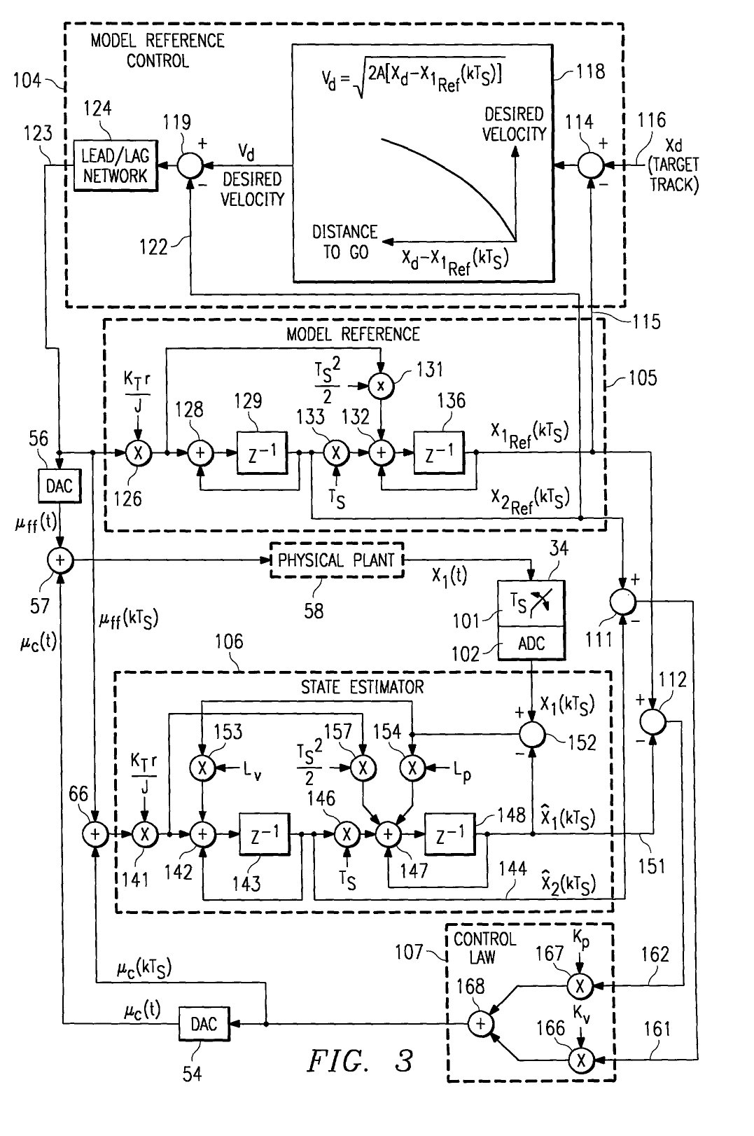

FIG. 3 is a block diagram showing details of one exemplary control system of the type depicted in FIG. 2. Certain components in FIG. 3 are identical to components in FIG. 2, and therefore are identified with the same reference numerals. In particular, FIG. 3 shows the DAC 54, the DAC 56, the summing junction 57, the summing junction 66, the physical plant 58, and the analog-todigital converter circuit 34.

In FIG. 3, the circuit 34 is shown diagrammatically as having a sampling portion 101 and a conversion portion 102. This reflects the fact that conventional analog-todigital converter circuits periodically sample an input signal and then convert the sampled value into a digital output. Accordingly, the sampling portion 101 represents the circuitry which samples the signal from the physical plant 58 at periodic points in time that are spaced by a time interval Tₛ. The conversion portion 102 is the circuitry which converts the sampled signal from sampling portion 101 into a digital output.

The control system of FIG. 3 also includes a model reference control 104, a model reference 105, a state estimator 106, and a control law 107, which respectively correspond functionally to the components 70, 68, 60 and 64 in FIG. 2. FIG. 3 also includes two junctions 111 and 112, which together correspond functionally to the junction 62 of FIG. 2.

The model reference control 104 has a junction 114 that subtracts a model reference position value 115 produced by the model reference 105 from an input 116 which is a position value representing a target track. The difference generated by the junction 114 is supplied to a control block 118, which determines a desired velocity Vd. In particular, the desired velocity Vd is the square root of a quantity which is the difference from junction 114 multiplied by a gain 2a. The desired velocity Vd from A block 118 is supplied to a junction 119. The junction 119 subtracts from the desired velocity Vd a model reference velocity value 122 received from the model reference 105. The output of the junction 119 is a feedorward control value 123, which is supplied to the DAC 56 and to the summing junction 66.

The model reference 105 includes a gain element 126, which receives as an input the feedforward control value 123 from the model reference control 104. Gain element 126 applies to the feedforward control value a gain K_{T}r/J, where K_{T} is a torque constant of the voice coil motor 16 in the physical plant 58, r is the radial distance along the arm 18 (FIG. 1) from the axle 19 to the read/write head 20, and J is the inertia associated with the voice coil motor 16. The output of the gain element 126 is supplied through a summing junction 128 to a delay block 129, delay block 129 effecting a delay Ts of one sampling interval.

The output of the delay block 129 serves as the model reference velocity value 122, is supplied to the summing junction 128, and is also supplied to an input of a further gain element 133, which applies to it a gain Ts. The output of gain element 126 is supplied to a further gain element 131, which applies a gain of Tₛ²/2. The outputs of gain elements 131 and 133 are supplied to a summing junction 132, the output of summing junction 132 being supplied to a further delay block 136. The delay block 136 creates a delay Tₛ of one sampling interval. The output of delay block 136 is supplied to an input of the summing junction 132, and also serves as the model reference position value 115.

The state estimator 106 includes a gain element 141 which receives the output from summing junction 66, and which applies to the output of junction 66 a gain K_{T}r/J, which is the same gain used by the gain element 126 of the model reference 105. The output of gain element 141 is supplied to a summing junction 142, the output of which is supplied to a delay block 143. The delay block 143 effects a delay Tₛ of one sampling interval. The output of delay block 143 is supplied to an input of the summing junction 142, and serves as a state estimation velocity value 144. The output of delay block 143 is also supplied to a gain element 146, which applies to it a gain Tₛ. The output of gain element 146 is supplied to a summing junction 147, the output of which is supplied to a further delay block 148. The delay block 148 effects a delay Tₛ of one sampling interval. The output of delay block 148 is supplied to an input of the summing junction 147, and also serves as a state estimation position value 151.

The output of the delay block 148 is also supplied to a junction 152, which takes a position error value from the output of the A/D converter circuit 34, and subtracts from it the state estimation position value 151 from delay block 148. The output of junction 152 is coupled to a gain element 153 and to a gain element 154, which apply to it respective gains of kv and kp. The gain kv is a velocity gain, and the gain Kp is a position gain. The output off the gain element 153 is coupled to an input of the summing junction 142, and the output of the gain element 154 is coupled to an input of the summing junction 147. The output of gain element 141 is coupled to the input of a further gain element 157, which applies a gain of Tₛ²/2. The output of gain element 157 is applied to an input of the summing junction 147.

The junction 111 subtracts from the model reference velocity value 122 the state estimation velocity value 144, to obtain a velocity error value 161. The junction 112 subtracts from the model reference position value 115 the state estimation position value 151, to obtain a position error value 162.

The control law 107 includes a gain element 166, which receives the velocity error value 161 and applies to it a gain kᵥ. The control law 107 also includes a further gain element 167, which receives the position error value 162 and applies to it a gain kₚ. The gains kᵥ and kₚ are respectively a velocity gain and a position gain, and are typically different from the velocity and position gains kv and kp used by gain elements 153 and 154. The outputs of the gain elements 166 and 167 are applied to inputs of a summing junction 168, the output of which is supplied to the DAC 54 and the summing junction 66. The operation of the system shown in FIG. 3 is equivalent to the operation of the system shown in FIG. 2, and is therefore not described here in detail.

The present invention provides numerous technical advantages. One such technical advantage includes the capability to use two low-precision DACs in place of one high-precision DAC, which is facilitated by the use of a model reference control technique. The model reference control does not control the actuator directly, but instead controls the model reference, and the actuator is controlled as a slave. Because the two low-precision DACs can be implemented with low-precision components, they can be fabricated in a cost-effective manner in the same integrated circuit as a digital signal processor, using a low-precision semiconductor process, which is not practical for a high-precision DAC that requires a high-precision semiconductor process. When implemented with a digital signal processor, the control is very precise and may be adjusted to avoid excitation of high frequency dynamics, such as mechanical resonances that usually occur in direct actuator control.

The use of two low-precision DACs in place of one high-precision DAC also results in reduced circuitry or silicon area, and reduced power consumption. Reduced power consumption is advantageous, especially for portable applications such as laptop and notebook computers, while reduced circuitry or silicon area results in lower overall fabrication costs. Another technical advantage of the present invention includes improved tracking resolution and performance. Other technical advantages are readily apparent to one skilled in the art from the following figures, description, and claims.

Although one embodiment has been illustrated and described in detail, it should be understood that various and numerous changes, substitutions, and alterations can be made therein without departing from the present invention. For example, although the present invention has been depicted and described as having a control section which is implemented by a control program executed by a digital signal processor, the control section could be implemented in a different manner, such as with an electronic circuit that directly implements the control functions with appropriate conventional control subcircuits. Further, although the present invention has been depicted and described as having a control section to control an actuator which is a voice coil motor, other types of actuators could be used in a system embodying the present invention.

Also, it should be understood that the direct connections illustrated herein could be altered by one skilled in the art such that two of the disclosed components or elements are coupled to one another through an intermediate device or devices, without being directly connected, while still achieving the desired results demonstrated by the present invention. Other examples of changes, substitutions, and alterations are readily ascertainable by one skilled in the art, and could be made without departing from the spirit and scope of the present invention as defined by the following claims.

What is claimed is:

1. A control system for controlling an apparatus which includes an actuator that has a movable member and that urges movement of the member in response to an actuator control signal, and which is operable to generate a digital position error signal representing an actual state of the member, said control system comprising:
a first control portion responsive to an input signal representing a target position of the member, and operable in response to the input signal to utilize a model reference control technique to generate a digital first control signal representing a movement of the member, and to generate a second control signal representing an expected response of the actuator to the digital first control signal;
a second control portion responsive to the digital position error signal, the digital first control signal, and the second control signal, and operable to generate in response thereto a digital third control signal representing a movement of the member;
a first digital to analog converter operable to convert the digital first control signal to an analog first control signal;
a second digital to analog converter operable to convert the digital third control signal to an analog third control signal; and
a junction responsive to the analog first control signal and the analog third control signal, and operable to generate the actuator control signal by combining the analog first control signal and the analog third control signal in a manner giving the analog first control signal greater weight than the analog third control signal.

2. A control system according to claim 1, wherein said first control portion includes:
a model reference of the actuator responsive to a feedforward control signal representing an operation to be effected by the actuator in order to place the member in the target position, and operable to generate a model control signal representing an expected response of the actuator to the feedforward control signal; and
a model reference control circuit responsive to the model control signal and the input signal representing the specified state of the actuator, and operable to generate the feedforward control signal in response to the model control signal and the input signal, wherein the feedforward control signal is a digital signal;
the first digital control signal being the feedforward control signal, and the second digital control signal being the model control signal.

3. A control system according to claim 1, wherein said second control portion includes:
a summing arrangement operable to receive the digital first control signal and the digital third control signal, and operable to generate a digital positioning signal by adding the digital first control signal and the digital third control signal in a manner giving the digital first control signal greater weight than the digital third control signal;
a state estimator responsive to the digital positioning signal and the digital position error signal, and operable to generate a state estimation signal representing an estimated state of the actuator;
a summing arrangement responsive to the second control signal and the state estimation signal, and operable to generate a state error signal by subtracting the state estimation signal from the second control signal; and
a control law responsive to receive the state error signal and operable to generate a correction control signal;
the digital third control signal being the correction control signal.

4. A control system according to claim 1, wherein the second control signal includes information representing an expected position of the member.

5. A control system according to claim 1, wherein the second control signal includes information representing an expected velocity of the member.

6. A control system according to claim 1, wherein the second control signal includes information representing an expected acceleration of the member.

7. A control system according to claim 1, wherein the second control signal includes information representing an expected position, velocity and acceleration of the member.

8. A control system according to claim 1, wherein the state estimation signal includes information representing an estimated position of the member.

9. A control system according to claim 1, wherein the state estimation signal includes information representing an estimated velocity of the member.

10. A control system according to claim 1, wherein the state estimation signal includes information representing an estimated acceleration of the member.

11. A control system for controlling a hard disk drive having a rotatably supported disk, a read/write head which is movable relative to the disk and which outputs an analog servo wedge signal read from the disk, and an actuator operable to urge movement of the read/write head relative to the disk in response to an analog positioning signal, said control system comprising:
a position-error-signal channel operable to generate an analog position error signal in response to the analog servo wedge signal;
an analog-to-digital converter circuit operable to convert the analog position error signal to a digital position error signal;
a digital signal processor operable to generate digital positioning information as a function of the digital position error signal, said digital signal processor utilizing a model reference control technique in generating the digital positioning information; and
a digital-to-analog converter operable to convert the digital positioning information into the analog positioning signal.

12. A control system according to claim 11, wherein the digital positioning information generated by said digital signal processor includes:
a digital first positioning signal component; and
a digital second positioning signal component; and
wherein said digital-to-analog converter includes:
a first digital-to-analog converter operable to convert the digital first positioning signal component into an analog first positioning signal component;
a second digital-to-analog converter operable to convert the digital second positioning signal component into an analog second positioning signal component; and
a summing arrangement operable to generate the analog positioning signal by combining the analog first positioning signal component and the analog second positioning signal component in a manner giving the analog first positioning signal component greater weight than the analog second positioning signal component.

13. A control system according to claim 11, further comprising:
a power amplifier operable to amplify the analog positioning signal to generate an amplified analog positioning signal which is applied to the actuator.

14. A control system according to claim 11, wherein said digital-to-analog converter and said digital signal processor are fabricated in a single piece of semiconductor material.

15. A control system according to claim 11, wherein said digital-to-analog converter circuit and said digital signal processor are fabricated in a single piece of semiconductor material which is silicon.

16. A control system according to claim 11, wherein said digital signal processor is further operable to utilize a state estimator technique in generating the digital positioning signal.

17. A control system according to claim 11, wherein said digital signal processor is further operable to utilize a control law in generating the digital positioning signal.

18. A control system according to claim 11, wherein the digital positioning information generated by said digital signal processor includes:
a digital first positioning signal component; and
a digital second positioning signal component;
said digital signal processor being operable to utilize said model reference control technique to generate the digital first positioning signal component; and
said digital signal processor being operable to utilize a state estimator technique to generate a state estimate signal in response to the digital positioning signal and the digital position error signal, and being operable to utilize a control law technique to generate the digital second positioning signal component in response to the state estimate signal and said model reference control technique;
said digital-to-analog converter including:
a first digital-to-analog converter operable to convert the digital first positioning signal component into an analog first positioning signal component;
a second digital-to-analog converter operable to convert the digital second positioning signal component into an analog second positioning signal component; and
a summing arrangement operable to generate the analog positioning signal by combining the analog first positioning signal component and the analog second positioning signal component in a manner giving the analog first positioning signal component greater weight than the analog second positioning signal component.

19. A method for controlling an apparatus which includes an actuator that has a movable member and that urges movement of the member in response to an actuator control signal, and which is operable to generate a digital position error signal representing an actual state of the member, said method comprising the steps of:
using a model reference control technique responsive to an input signal representing a target position of the member to generate a digital first control signal which represents a movement of the member, and to generate a second control signal which represents an expected response of the actuator to the digital first control signal;
generating a digital third control signal in response to the digital position error signal, the digital first control signal, and the second control signal, the digital third control signal representing a movement of the member;
converting the digital first control signal into an analog first control signal;
converting the digital third control signal into an analog third control signal; and
generating the actuator control signal by combining the analog first control signal and the analog third control signal in a manner giving the analog first control signal greater weight than the analog third control signal.

20. A method according to claim 19, wherein said step of using said model reference control technique includes the steps of:
generating a model control signal representing an expected state of the actuator in response to a feedforward control signal which represents an operation to be effected by the actuator in order to place the member in a target position; and
generating the feedforward control signal in response to the model control signal and the input signal, wherein the feedforward control signal is a digital signal;
the digital first control signal being the feedforward control signal, and the second control signal being the model control signal.

21. A method according to claim 18, wherein said step of generating the digital third control signal includes the steps of:
generating a digital positioning signal by adding the digital first control signal and the digital third control signal in a manner giving the digital first control signal greater weight than the digital third control signal;
generating in response to the digital positioning signal and the digital position error signal a state estimation signal representing an estimated state of the actuator;
generating a state error signal by subtracting the state estimation signal from the second control signal; and
generating in response to the state error signal a correction control signal which is the digital third control signal.
